(19) United States
(12) Patent Application Publication
(10) Pub. No.: US 2006/0095941 A1
(43) Pub. Date: May 4, 2006

(54) Device identification

(76) Inventors: Mark W. Fidler, Granite Bay, CA (US); Alan C. Berkema, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/980,105

(22) Filed: Nov. 1, 2004

(51) Int. Cl. H04N 7/18

(52) U.S. Cl. 725/81; 725/80; 725/74

(57) ABSTRACT

A device identification method includes a first device receiving a multimedia identifier from a second device. The first device presents the multimedia identifier, and then identifies the second according to a user response to the presentation of the multimedia identifier.

Technology enabling communication between electronic devices is evolving daily. Both wired and wireless protocols allow devices to exchange electronic data for a multitude of purposes. UWB (Ultrawideband), Bluetooth, 802.11 are examples of wireless radio communication protocols for establishing device “pairings.” A pairing, for example, can be between a mobile phone and a headset, a mouse and a personal computer, or a PDA (personal digital assistant) and a printer. Once paired, devices are able to interact as if they were physically connected. This assumes, of course, that the paired devices remain within communication range with one another.

In an environment containing multiple devices of similar and/or differing types, it can be difficult to identify a particular device with which a connection is desired. Imagine, for example, a user of a PDA (Personal Digital Assistant) who desires to send a document to a particular printer over a wireless connection. That environment may have any number of available printers located in a multitude of physical locations. The limited user interface capabilities of a PDA can make it cumbersome for the user to identify and connect with the desired printer.

### DESCRIPTION OF THE DRAWINGS

FIGS. 1-3 illustrate exemplary environments in which embodiments of the present invention can be implemented.

FIG. 4 is a block diagram showing physical and logical components of a requesting device and an available device, according to an embodiment of the present invention.

FIG. 5 is a block diagram showing connection logic program elements, according to an embodiment of the present invention.

FIG. 6 is a block diagram showing security logic program elements, according to an embodiment of the present invention.

FIG. 7 is an exemplary flow diagram illustrating steps to enable device identification, according to an embodiment of the present invention.

FIG. 8 is an exemplary flow diagram illustrating steps to enable device selection, according to an embodiment of the present invention.

FIG. 9 is an exemplary flow diagram illustrating steps to limit connection based on device identification, according to an embodiment of the present invention.

FIG. 10 is an exemplary flow diagram illustrating steps to present multimedia identifier content.

### DETAILED DESCRIPTION OF THE INVENTION

INTRODUCTION: Many electronic devices are provided with a limited but useful user interface of one form or another. A typical PDA (Personal Digital Assistant), for example, allows a user to input information or commands through a touch screen while being capable of presenting visual content (text and still and motion video) using the screen and audible content through a speaker. Photo printers often include a display for previewing images and can be equipped with speakers for presenting audible content. Televisions, of course, include a display and speakers and can be remotely controlled through a menu driven interface.

With the advent or wireless communication protocols such as UWB, Bluetooth, and 802.11, a device like a PDA or cellular telephone can, for example, be enabled to exchange data with another computing device, send images to a photo printer, and to send audio and video content to a television. Before such exchanges can take place, the devices are “paired” or connected. However, the relatively limited user interface capabilities of such devices can make it cumbersome to identify a device with which a connection is desired.

To help a user more efficiently identify a particular device, embodiments of the present invention use multimedia identifiers that can be presented though relatively limited user interfaces. A multimedia device identifier is an electronic file containing content of differing media types such as audio content, textual content, and/or graphical content. The content of a multimedia identifier is capable of uniquely identifying a particular device and/or the user of the device. For example, a multimedia identifier for a PDA may include graphical content in the form of a photo image of the user or the device, audio content identifying the users name or describing the device, and textual content listing the users name or describing the device.

A set of devices available for connection broadcast their multimedia identifiers. A user's device receives and presents the multimedia identifiers. The device selectively presents the content of each identifier, according to the capabilities of its user interface. From the content presented, the user can more easily identify from the set of devices a particular device with which a connection is desired.

The description that follows is broken into sections. The first section, labeled “environments,” describes exemplary environments in which various embodiments of the present invention can be implemented. The second section, labeled “components,” describes exemplary logical and physical elements used to implement various embodiments of the present invention. The third section, labeled “operation,” describes exemplary steps taken to practice various embodiments of the present invention.

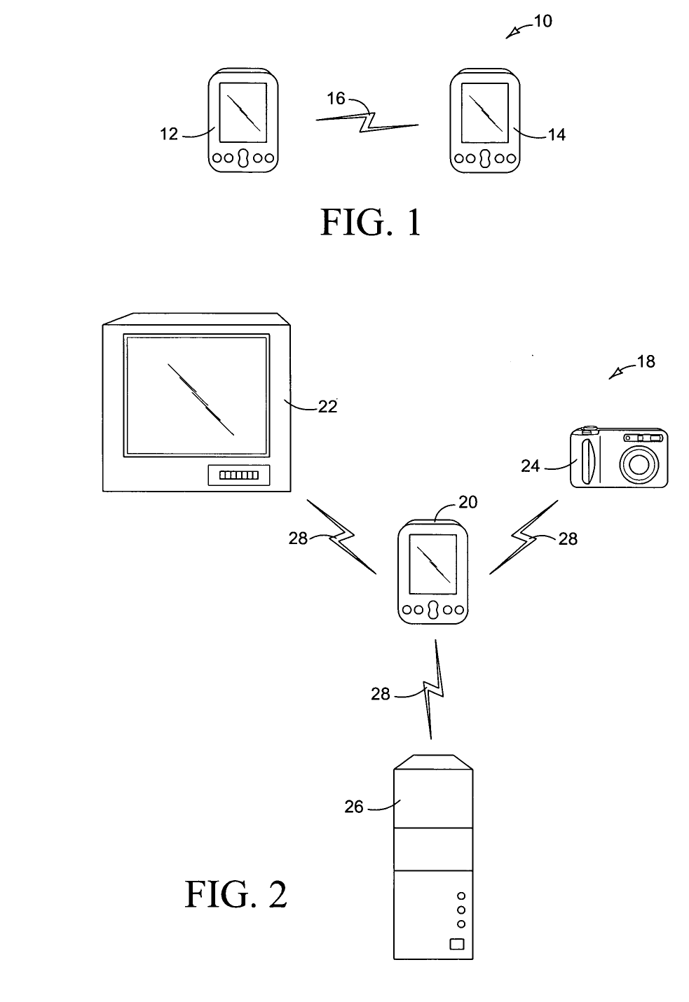

ENVIRONMENTS: FIGS. 1-3 illustrate exemplary environments in which various embodiments of the present invention can be implemented. Referring first to FIG. 1, environment 10 includes requesting PDA 12 and available PDA 14. The term requesting is used to describe a device that requests a connection with another device. The term available is used to describe a device that is available to connect with a requesting device. A given device, then, can be both a requesting device and an available device. This is true with PDA 12 and PDA 14 in FIG. 1.

Requesting PDA 12 and available PDA 14 can communicate via link 16. Link 16 is shown as a wireless connection. However, link 16 represents generally any one or combination of cable, wireless, or remote connections via telecommunication links, infrared links, radio frequency links, or any other connectors or systems that provide electronic communication.

In manners described in more detail below, requesting PDA 12 and available PDA 14 can use multimedia identifiers to establish a connection with one another for purposes such as exchanging data. The user of requesting PDA 12, for example, may desire to connect with available PDA 14 and inputs commands indicating this desire. Requesting PDA 12 searches link 16 for available devices and receives a multimedia identifier from available PDA 14. Requesting PDA 12 then presents the multimedia identifier for available PDA 14 allowing the user to confirm that a connection is desired with that device. Once confirmed, requesting PDA 12 sends its own multimedia identifier and a connection request to available PDA 14. Available PDA 14 presents to its user the multimedia identifier for requesting PDA 12 along with an indication that a connection is being requested. The user of available PDA 14 can either accept or reject the connection request.

Moving on to FIG. 2, environment 18 includes requesting PDA 20, available television 22, available camera 24, and available file server 26. Devices 20-26 can communicate via link 28. Link 28 is shown as a wireless connection. However, link 28 represents generally any one or combination of cable, wireless, or remote connections via telecommunication links, infrared links, radio frequency links, or any other connectors or systems that provide electronic communication.

In manners described in more detail below, requesting PDA 20 can use multimedia identifiers provided by devices 22-26 to identify a particular device with which a connection is desired. The user of requesting PDA 20, for example, may desire to connect with available file server 26 to perform a back-up. The user inputs commands indicating this desire. Requesting PDA 20 searches link 28 for available devices and receives a multimedia identifiers from available devices 22-26. Requesting PDA 20 then presents the multimedia identifiers for available devices 22-26 allowing the user to identify and select available file server 26. Once selected requesting PDA 20 sends a connection request to available file server 26.

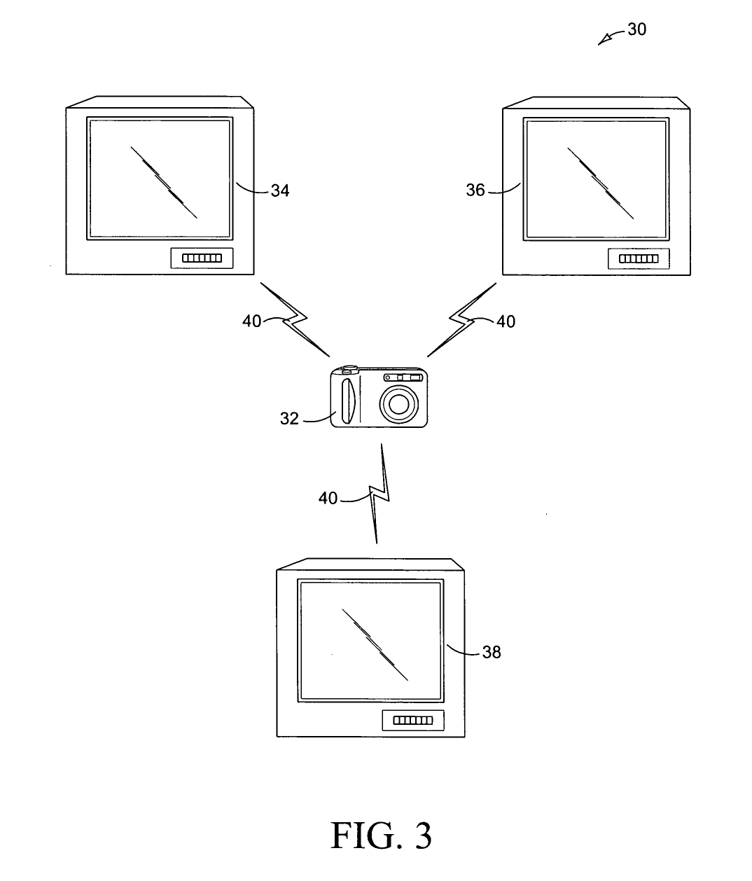

FIG. 3 illustrates environment 30 that includes requesting camera 32, and available televisions 34-38. Devices 34-38 can communicate via link 40. Link 40 is shown as a wireless connection. However, link 40 represents generally any one or combination of cable, wireless, or remote connections via telecommunication links, infrared links, radio frequency links, or any other connectors or systems that provide electronic communication.

In manners described in more detail below, requesting camera 32 can use multimedia identifiers provided by available televisions 34-38 to identify a particular device with which a connection is desired. The user of requesting camera 32, for example, may desire to connect with available television 38 to display one or more images. Available television 38 may, for example be in the room with the user while available televisions 34 and 36 may be in other rooms or other buildings. The user enters commands indicating this desire. Requesting camera 32 searches link 40 for available devices and receives a multimedia identifiers from available televisions 34-38. Requesting camera 32 then presents the multimedia identifiers for available televisions 34-38 allowing the user to identify and select available television 38. The multimedia identifier for available television 38 may include visual content uniquely identifying available television 38 that can be shown on a display supplied by requesting camera 32. That multimedia identifier may also include audio content that can be presented on a speaker supplied by requesting camera 32. Once available television 38 is identified and selected, requesting camera 32 sends a connection request.

The three environments 10, 18, and 30 shown in FIGS. 1-3 are merely examples of environments in which embodiments of the present invention may be implemented. Various embodiments can be implemented in a wide variety of other environments.

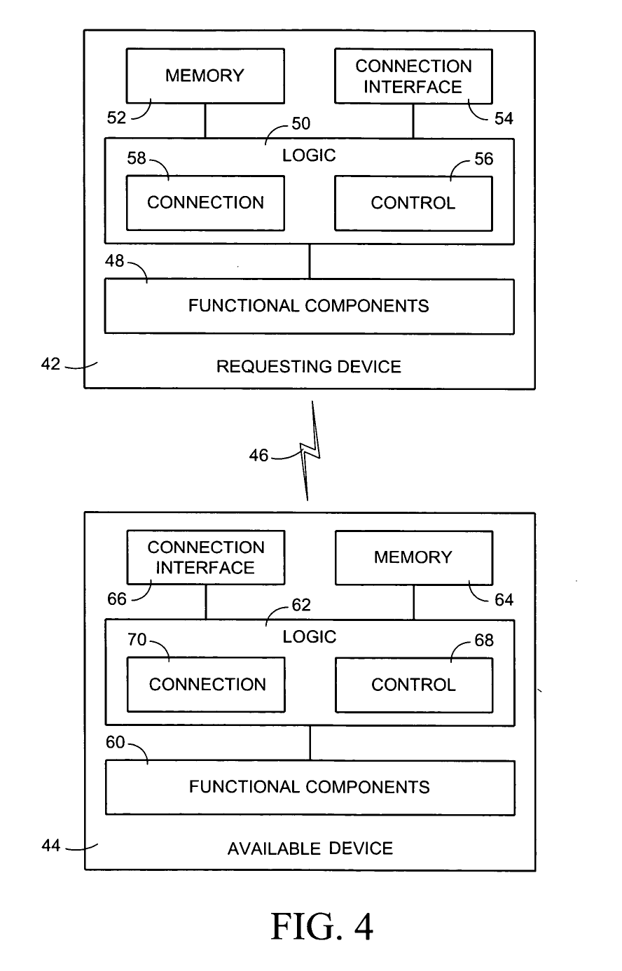

COMPONENTS: FIG. 4 is an exemplary block diagram showing the physical and logical components of an exemplary requesting device 42 and an exemplary available device 44. Here, requesting device 42 and available device 44 represent any devices capable of communicating with one another over link 46. Devices 42 and 44 may also be capable of performing functions independently of one another. Using the examples from FIGS. 1-3, devices 42 and 44 can, for example, be PDAs, cameras, content servers, televisions and even printers and desktop computers.

Requesting device 42 includes functional components 48, logic 50, memory 52, and connection interface 54. Functional components 48 represent generally the physical components capable of performing the functions for which requesting device 40 is designed. Function components 48 include user interface elements as well as a microprocessor for executing logic 50. Logic 50 represents the programs capable of directing or being processed by functional components 48. Memory 52 represents generally any memory capable of being utilized by logic 50 to store multimedia identifiers. Connection interface 68 represents generally any hardware and program instructions enabling requesting device 42 to exchange data with available device 44.

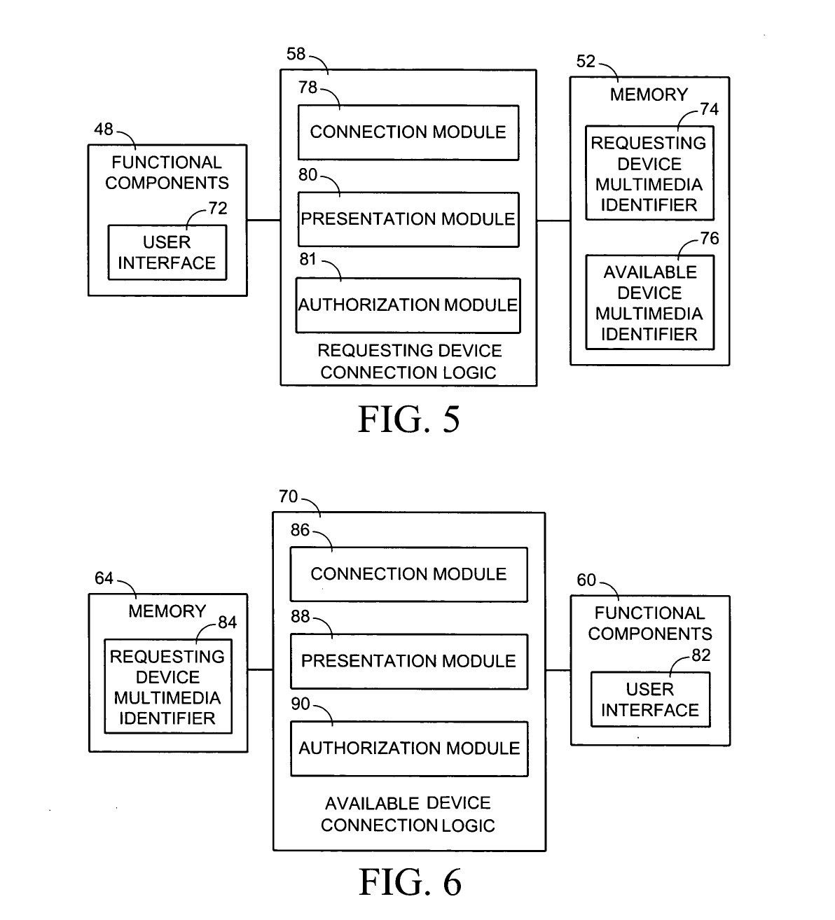

Logic 50 includes control logic 56 and connection logic 58. Control logic 56 represents programs having instructions that when executed guide the operation of functional components 48. Connection logic 58, described in more detail with reference to FIG. 5, represents programs capable of helping to establish and maintain a connection between requesting device 42 and available device 44.

Available device 44 includes functional components 60, logic 62, memory 64, and connection interface 66. Functional components 60 represent generally the physical components capable of performing the functions for which available device 44 is designed. Functional components 60 include user interface elements as well as a microprocessor for executing logic 62. Logic 62 represents programs capable of directing or being processed by functional components 60. Memory 64 represents any memory capable of being utilized by logic 62 and functional components 60 to store multimedia identifiers. Connection interface 66 represents generally any hardware and program instructions enabling available device 44 to exchange data with requesting device 42 over link 46.

As shown, logic 62 includes control logic 68 and connection logic 70. Control logic 68 represents programs capable of directing functional components 60. For example, control logic 68 might include a word processor and an operating system. Control logic 68 could then direct a display to present a user interface for entering text. Connection logic 70, described in more detail with reference to FIG. 6, represents programs capable of helping to selectively establish and maintain a connection between requesting device 42 and available device 44.

FIG. 5 is an exemplary block diagram illustrating the logical components of connection logic 58 for requesting device 42. Here, connection logic 58 includes connection module 78, presentation module 80, and authorization module 81. Connection module 78 represents program instructions capable of requesting a connection with available device 44. Presentation module 80 represents program instructions capable of sending, receiving, and presenting multimedia identifiers. For example, presentation module 80 is also configured to receive a multimedia identifier 76 into memory 52 from another device such as available device 44. Presentation module 80 is capable of presenting multimedia identifier 76 based on the capabilities of user interface 72. Multimedia identifier 76 may include content that cannot be presented on requesting device 42. For example, multimedia identifier 76 may include audio content and user interface 72 may not include a speaker. Presentation module 80, then, is responsible for examining the content in multimedia identifier 76 and presenting only that content supported by user interface 72.

Authorization module 81 represents program instructions capable of providing connection module 78 with credentials required to access available device 44. Such credentials, for example, could include a username and/or a password.

FIG. 6 is an exemplary block diagram illustrating the logical components of connection logic 70 for available device 44. Here, connection logic 70 includes connection module 86, presentation module 88, and authorization module 90. Connection module 86 represents program instructions capable of establishing a connection with a device such as requesting device 42 (FIG. 4) in response to a connection request.

Presentation module 88 represents program instructions capable of sending, receiving, and presenting multimedia identifiers. For example, presentation module 88 is configured to receive a multimedia identifier 84 into memory 64 from another device such as requesting device 42. Presentation module 88 is also configured to present multimedia identifier 84 based on the capabilities of user interface 82. Multimedia identifier 84 may include content that cannot be presented on available device 44. For example, multimedia identifier 84 may include graphical content and user interface 82 may not include an appropriate display. Presentation module 88, then, is responsible for examining the content in multimedia identifier 84 and presenting only that content supported by user interface 82.

Authorization module 90 represents program instructions capable of instructing connection module 86 to accept or reject a connection request, according to user input following the presentation of a multimedia identifier 84 for a device making the connection request. For example, a user of available device 44 may not want to allow a connection with requesting device 42. Upon presentation of multimedia identifier 84, the user of available device 44 can identify the source of the connection request and instruct that the request be rejected. Authorization module 90 may also be responsible for validating credentials received from requesting device 42.

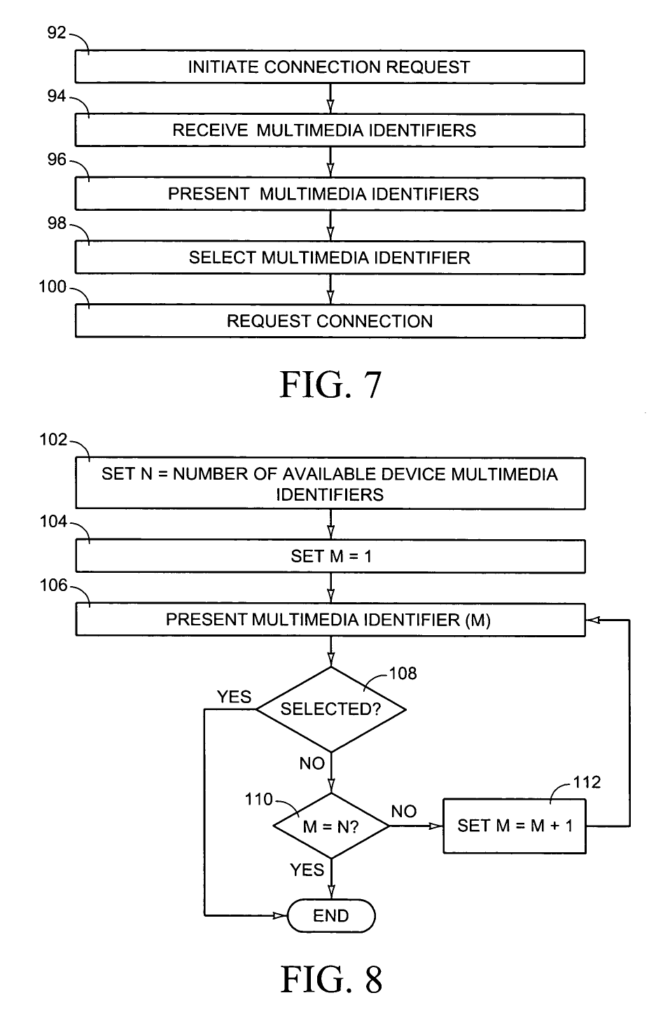

OPERATION: The operation of embodiments of the present invention will now be described with reference to FIGS. 7-10. FIG. 7 is an exemplary flow diagram that helps illustrate steps taken on and by a requesting device to identify a device with which a connection is desired. A user of a requesting device initiates a connection request (step 92). The requesting device searches for devices available for connection and receives multimedia identifiers form the available devices (step 94). The multimedia identifiers are presented (step 96). From the presented multimedia identifiers, the user recognizes the device with which a connection is desired and selects its identifier (step 98). A connection request is sent to that device (step 100).

When presenting multimedia identifiers in step 96, it may be impracticable to present the identifiers simultaneously. This is especially true when presenting audio content or when the available user interface has limited or no display capabilities. FIG. 8 is an exemplary flow diagram expanding on step 96 to allow sequential presentation of multimedia identifiers. A variable (N) is set to the number of available device multimedia identifiers received in step 94 (step 102). A variable (M) is set to one (step 104). Available device multimedia identifier (M) is presented (step 106). It is then determined if the user has selected multimedia identifier (M) (step 108). If selected, the sub process ends. If not selected, it is determined if (M) equals (N) (step 110). If it does, the process ends. If not, (M) is incremented by one and the sub process repeats with step 106 (step 112).

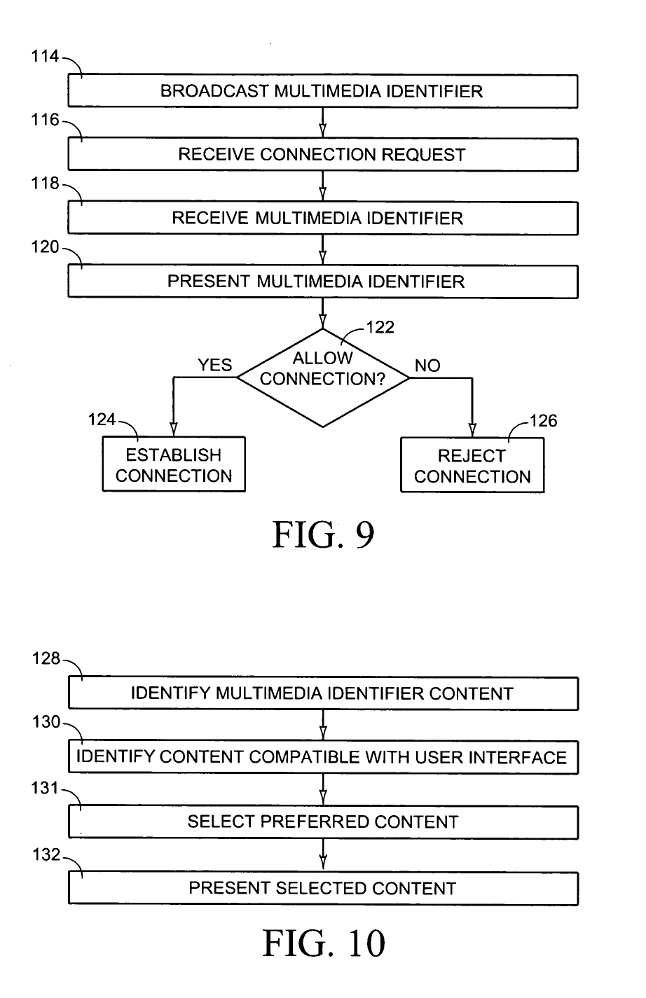

FIG. 9 is an exemplary flow diagram that helps illustrate steps taken on and by an available device. The available device broadcasts its multimedia identifier (114) and eventually receives a connection request (step 116). A multimedia identifier for the requesting device is also received (step 118). The requesting device multimedia identifier is presented (step 120). It is then determined if user input directs that the connection request be allowed (step 122). If allowed, a connection is established with the requesting device (step 124). If not, the connection request is rejected (step 126).

As noted above, a given multimedia identifier may include content that cannot be presented by a particular requesting device or by a particular available device. Additionally, a user of a particular device may prefer one type of content over another even though that device can present both types. For example, a device may be able to present both motion and still images and the user may prefer presenting motion video.

FIG. 10 is an exemplary flow diagram expanding on steps 96, 106, and 120 in FIGS. 7, 8, and 9 to allow selective multimedia identifier presentation. The content of a multimedia identifier is identified (step 128). This can include identifying whether the multimedia identifier includes visual and/or audible content. It can also go further and identify the format of the visual or audible content. Format examples for visual content include MPEG, JPEG, plain text, rich text, and a multitude of others. Examples of audible content formats include MIDI, MP3, WAV and a multitude of others. Content compatible with the user interface of the presenting device is identified (step 130). Preferred content, from the identified compatible content, is then identified and selected (step 131). The selected content is then presented (step 132).

CONCLUSION: The schematic diagrams of FIGS. 1-3 illustrate three exemplary environments in which embodiments of the present invention may be implemented. Implementation, however, is not limited to these environments. The diagrams of FIGS. 4-6 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 7-10 show a specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A device identification method, comprising
a first device receiving a multimedia identifier from a second device;
the first device presenting the multimedia identifier; and
the first device identifying the second device according to a user response to the presentation of the multimedia identifier.

2. The method of claim 1, wherein:
receiving comprises the first device receiving a plurality of multimedia identifiers from a plurality of second devices, each multimedia identifier being received from and associated with one of the plurality of second devices;
presenting comprises the first device presenting one or more of the multimedia identifiers; and
identifying comprises the first device identifying one of the plurality of second devices according to a user response indicating a selection of the multimedia identifier associated with that second device.

3. The method of claim 2, wherein presenting comprises sequentially presenting the plurality of multimedia identifiers until a user response indicates a selection of a particular multimedia identifier.

4. The method of claim 1, further comprising the first device requesting a connection with the identified second device.

5. The method of claim 1, wherein the multimedia identifier is received with a connection request from the second device, the method further comprising establishing a connection with the second device if authorized following the presentation of the multimedia identifier.

6. The method of claim 1, wherein the multimedia identifier includes content of differing types and wherein presenting comprises presenting at least one type of content.

7. The method of claim 1, wherein presenting comprises the first device presenting the multimedia identifier according to the user interface capabilities of the first device.

8. The method of claim 7, wherein presenting comprises selecting, from the multimedia identifier, preferred content that is compatible with the user interface and presenting the selected content.

9. A device identification method, comprising:
a requesting device receiving a multimedia identifier from an available device;
presenting the multimedia identifier through a user interface of the requesting device;
identifying the available device as a device to connect with according to a user response to the presentation of the multimedia identifier; and
requesting a connection with the available device.

10. The method of claim 9, wherein the multimedia identifier includes content of differing types and wherein presenting comprises presenting at least one type of content.

11. The method of claim 9, wherein presenting comprises presenting the multimedia identifier according to capabilities of the user interface.

12. The method of claim 11, wherein presenting comprises selecting, from the multimedia identifier, preferred content that is compatible with the capabilities of the user interface and presenting the selected.

13. The method of claim 9, wherein:
receiving comprises the requesting device receiving a plurality of multimedia identifiers from a plurality of available devices, each multimedia identifier being received from and associated with one of the plurality of available devices;
presenting comprises the requesting device presenting one or more of the multimedia identifiers; and
identifying comprises the requesting device identifying one of the plurality of available devices to connect with according to a user response indicating a selection of the multimedia identifier associated with that available device.

14. The method of claim 13, wherein presenting comprises sequentially presenting the plurality of multimedia identifiers until a user response indicates a selection of a particular multimedia identifier.

15. The method of claim 9, further comprising:
sending a multimedia identifier for the requesting device to the available device;
the available device receiving and presenting the multimedia identifier for the requesting device; and
the available device accepting or rejecting the connection according to user input in response to the presentation of the multimedia identifier for the requesting device.

16. A device identification method, comprising
an available device receiving a connection request and a multimedia identifier from a requesting device;
presenting the multimedia identifier though a user interface of the available device;
accepting or rejecting the connection request according to user input in response to the presentation of the multimedia identifier for the requesting device.

17. The method of claim 16, wherein the multimedia identifier includes content of differing types and wherein presenting comprises presenting at least one type of content.

18. The method of claim 16, wherein presenting comprises presenting the multimedia identifier according to capabilities of the user interface.

19. The method of claim 18, wherein presenting comprises selecting, from the multimedia identifier, preferred content that is compatible with the capabilities of the user interface and presenting the selected content.

20. A computer readable medium having instructions for:
receiving, at a first device, a multimedia identifier from a second device;
causing the first device to present the multimedia identifier; and
identifying the second device according to a user response to the presentation of the multimedia identifier.

21. The medium of claim 20, wherein:
the instructions for receiving comprise instructions for receiving, at the first device, a plurality of multimedia identifiers from a plurality of second devices, each multimedia identifier being received from and associated with one of the plurality of second devices;
the instructions for causing comprise instructions for causing the first device to present one or more of the multimedia identifiers; and
the instructions for identifying comprise instructions for identifying one of the plurality of second devices according to a user response indicating a selection of the multimedia identifier associated with that second device.

22. The medium of claim 21 wherein the instructions for causing comprise instructions for causing the first device to sequentially present the plurality of multimedia identifiers until a user response indicates a selection of a particular multimedia identifier.

23. The medium of claim 20, having further instructions for requesting, for the first device, a connection with the identified second device.

24. The medium of claim 20, wherein the multimedia identifier is received with a connection request from the second device, the medium having further instructions for establishing a connection with the second device if authorized following the presentation of the multimedia identifier.

25. The medium of claim 20, wherein the multimedia identifier includes content of differing types and wherein the instructions for causing comprise instructions for causing the first device to present at least one type of content.

26. The medium of claim 20, wherein the instructions for causing comprise instructions for causing the first device to present the multimedia identifier according to the user interface capabilities of the first device.

27. The medium of claim 26, wherein the instructions for causing comprise instructions for selecting, from the multimedia identifier, preferred content that is compatible with the user interface and causing the first device to present the selected content.

28. A computer readable medium having instructions for:
receiving, at a requesting device, a multimedia identifier from an available device; available device;
causing the requesting device to present the multimedia identifier though a user interface of the requesting device;
identifying the available device as a device for the requesting device to connect with according to a user response to the presentation of the multimedia identifier; and
requesting, for the requesting device, a connection with the available device.

29. The medium of claim 28, wherein the multimedia identifier includes content of differing types and wherein the instructions for causing comprise instructions for causing the requesting device to present at least one type of content.

30. The medium of claim 28, wherein the instructions for causing comprise instructions for causing the requesting device to present the multimedia identifier according to capabilities of the user interface.

31. The medium of claim 30, wherein the instructions for causing comprise instructions for selecting, from the multimedia identifier, preferred content that is compatible with the capabilities of the user interface and causing the requesting device to present the selected content.

32. The medium of claim 28, wherein the instructions for:
receiving comprise instructions for the receiving, at the requesting device, a plurality of multimedia identifiers from a plurality of available devices, each multimedia identifier being received from and associated with one of the plurality of available devices;
causing comprise instructions for the causing the requesting device to present one or more of the multimedia identifiers; and
identifying comprise instructions for identifying one of the plurality of available devices according to a user response indicating a selection of the multimedia identifier associated with that available device.

33. The medium of claim 32, wherein the instructions for causing comprise instructions for causing the requesting device to sequentially present the plurality of multimedia identifiers until a user response indicates a selection of a particular multimedia identifier.

34. A computer readable medium having instructions for:
receiving, at an available device, a connection request and a multimedia identifier from a requesting device;
causing the available device to present the multimedia identifier though a user interface of the available device;
accepting or rejecting the connection request according to user input in response to the presentation of the multimedia identifier for the requesting device.

35. The medium of claim 20, wherein the multimedia identifier includes content of differing types and wherein the instructions for causing comprise instructions for causing the available device to present at least one type of content.

36. The medium of claim 34, wherein the instructions for causing comprise instructions for causing the available device to present the multimedia identifier according to capabilities of the user interface.

37. The medium of claim 36, wherein the instructions for causing comprise instructions for selecting, from the multimedia identifier, preferred content that is compatible with the capabilities of the user interface and causing the available device to present the selected content.

38. A device identification system, comprising:
a user interface operable to present content and to receive user input;
connection logic operable to:
receive a multimedia identifier from an available device;
cause the user interface to present the multimedia identifier; and
identify the available device as according to a user response to the presentation of the multimedia identifier.

39. The system of claim 38, wherein the connection logic is operable to:
receive a plurality of multimedia identifiers from a plurality of available devices, each multimedia identifier being received from and associated with one of the plurality of available devices;
cause the user interface to present one or more of the multimedia identifiers; and
identify one of the plurality of available devices according to a user response through the user interface indicating a selection of the multimedia identifier associated with that second device.

40. The system of claim 39, wherein the connection logic is operable to sequentially present the plurality of multimedia identifiers until a user response indicates a selection of a particular multimedia identifier via the user interface.

41. The system of claim 38, wherein the connection logic is further operable to request a connection with the identified available device.

42. The system of claim 38, wherein the multimedia identifier includes content of differing types and wherein the connection logic is operable to cause the user interface to present at least one type of content.

43. The system of claim 39, wherein the connection logic is operable cause the user interface to present the multimedia identifier according to capabilities of the user interface.

44. The system of claim 43, wherein the connection logic is operable to select, from the multimedia identifier, preferred content that is compatible with the user interface and to cause the user interface to present the selected content.

45. A device identification system, comprising:
a user interface operable to present content and to receive user input;
security logic operable to:
receive a connection request from a requesting device;
receive a multimedia identifier from the requesting device;
cause the user interface to present the multimedia identifier; and
accept or reject the connection request according to a user response through the user interface.

46. The system of claim 45, wherein the multimedia identifier includes content of differing types and wherein the security logic is operable to cause the user interface to present at least one type of content.

47. The system of claim 45, wherein the security logic is operable to cause the user interface to present the multimedia identifier according to capabilities of the user interface.

48. The system of claim 47, wherein the security logic is operable to select, from the multimedia identifier, preferred content that is compatible with the capabilities of the user interface and to cause the user interface to present the selected content.

49. A device identification system, comprising:
a user interface operable to present content and to receive user input;
a means for receiving a multimedia identifier from an available device;
a means for causing the user interface to present the multimedia identifier; and
a means for identifying the available device as a device to connect with according to a user response to the presentation of the multimedia identifier.

50. A device identification system, comprising:
a user interface operable to present content and to receive user input;
a means for receiving a connection request from a requesting device;
a means for receiving a multimedia identifier from the requesting device;
a means for causing the user interface to present the multimedia identifier; and
a means for accepting or rejecting the connection request according to a user response through the user interface.
